(19) United States
(12) Patent Application Publication
(10) Pub. No.: US 2022/0097040 A1
(43) Pub. Date: Mar. 31, 2022

(54) LIQUID TRANSFER DEVICE

(71) Applicant: iCare Diagnostics International Co. Ltd., New Taipei City (TW)

(72) Inventors: SHUN-YAO CHENG, New Taipei (TW); JE-WEI CHIANG, New Taipei (TW); YU-SHENG CHANG, New Taipei (TW); YU-MIN WANG, New Taipei (TW); CHIA-HUA TSAI, New Taipei City (TW); CHUAN-CI HUANG, New Taipei City (TW)

(21) Appl. No.: 17/488,654

(22) Filed: Sep. 29, 2021

Related U.S. Application Data
(60) Provisional application No. 63/085,368, filed on Sep. 30, 2020.

(30) Foreign Application Priority Data
May 31, 2021 (CN) 202110604887.5

(51) Int. Cl. B01L 3/00

(52) U.S. Cl. CPC B01L 3/5023; B01L 2300/0854; B01L 2300/123; B01L 2400/0481; B01L 2300/0858

(57) ABSTRACT

A device for transferring liquids and liquid samples in certain quantities includes a pressing unit and a liquid extraction assembly. The pressing unit includes a first housing and a second housing. The first housing includes a first sidewall, a first top wall, and an extrusion portion. The second housing includes a second sidewall, a second top wall, and a receiving cavity. The first housing is received in the receiving cavity. The liquid extraction assembly includes a liquid extraction pipe, a liquid extraction head, and a first connecting portion. The first housing is configured to move back and forth along the receiving cavity to drive the extrusion portion to compress and deform the liquid extraction pipe. The liquid extraction assembly is detachably installed in pressing unit and is replaceable and suitable for single-use situations.

### FIELD

The subject matter relates to a liquid transfer device.

### BACKGROUND

Molecular diagnosis, morphological detection, and immunological detection mostly need to be carried out in laboratories. Detection processes are time-consuming, complex, inefficient, and inflexible, and detection devices are generally not portable. Transferring of a sample usually need to be done in a laboratory. Therefore, the detection cannot be carried out at any time and in any place, especially at home.

### BRIEF DESCRIPTION OF THE DRAWINGS

Implementations of the present technology will now be described, by way of example only, with reference to the attached figures.

FIG. 1 is a diagrammatic view of an embodiment of a liquid transfer device in a resting state according to the present disclosure.

FIG. 2 is a diagrammatic view of the liquid transfer device in a compressed state according to the present disclosure.

FIG. 3 is an exploded diagrammatic view of the liquid transfer device according to the present disclosure.

FIG. 4 is a cross-sectional view taken along IV-IV of FIG. 1.

FIG. 5 is a cross-sectional view taken along V-V of FIG. 2.

FIG. 6 is a cross-sectional view taken along VI-VI of FIG. 1.

FIG. 7 is a cross-sectional view of another embodiment of a liquid transfer device according to the present disclosure.

FIG. 8 is a front, top perspective view of an embodiment of a first housing of the liquid transfer device according to the present disclosure.

FIG. 9 is a rear, bottom perspective view of the first housing according to the present disclosure.

FIG. 10 is a front, top perspective view of an embodiment of a second housing according to the present disclosure.

FIG. 11 is a rear, bottom perspective view of the second housing according to the present disclosure.

FIG. 12 is a diagrammatic view of an embodiment of a liquid extraction assembly according to the present disclosure.

FIG. 13 is a diagrammatic view of a pressing unit separated from the liquid extraction assembly according to the present disclosure.

### DETAILED DESCRIPTION

It will be appreciated that for simplicity and clarity of illustration, where appropriate, reference numerals have been repeated among the different figures to indicate corresponding or analogous components. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain portions may be exaggerated to better illustrate details and features of the present disclosure.

The term “comprising,” when utilized, means “including, but not necessarily limited to”; it specifically indicates open-ended inclusion or membership in the so-described combination, group, series, and the like.

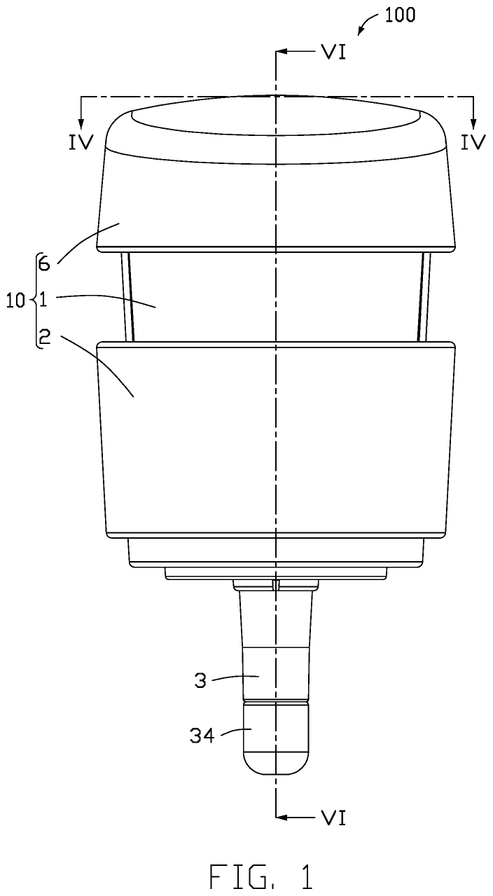

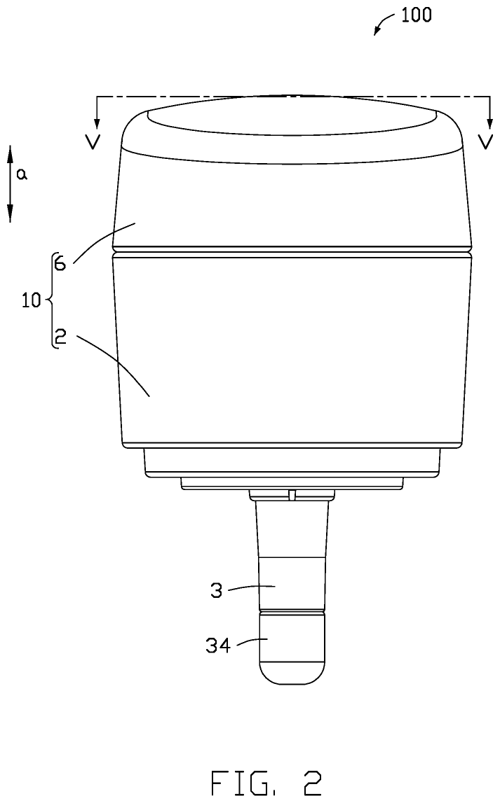

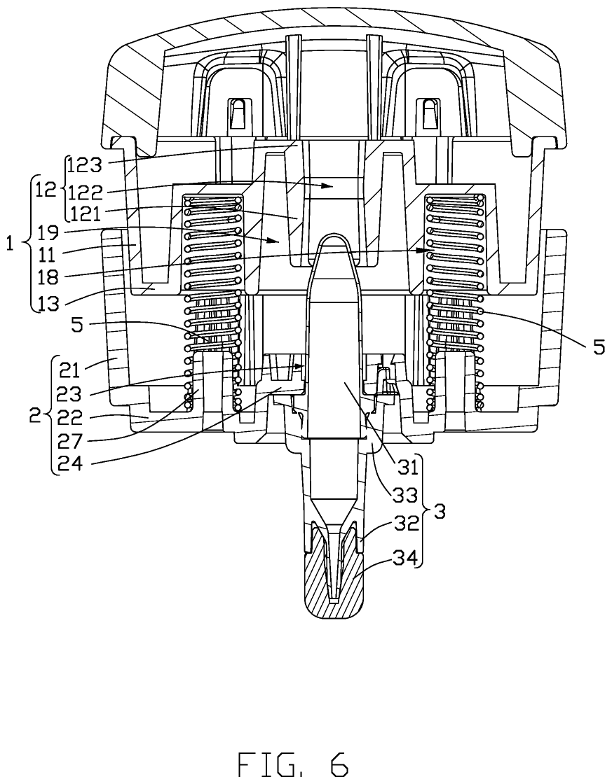

FIGS. 1 to 6 illustrate a liquid transfer device 100, which includes a pressing unit 10 and a liquid extraction assembly 3. The pressing unit 10 includes a first housing 1 and a second housing 2. The first housing 1 includes a first sidewall 11, a first top wall 13, and an extrusion portion 12. The first sidewall 11 is connected to the first top wall 13. The extrusion portion 12 is disposed on the first top wall 13. The second housing 2 includes a second sidewall 21 and a second top wall 22. The second sidewall 21 is connected to the second top wall 22. The second sidewall 21 and the second top wall 22 cooperatively define a receiving cavity 4. The first housing 1 is received in the receiving cavity 4. The liquid extraction assembly 3 includes a liquid extraction pipe 31, a liquid extraction head 32, and a first connecting portion 33. The liquid extraction assembly 3 extends into the receiving cavity 4 through a side of the second top wall 22 away from the receiving cavity 4 and corresponds to the extrusion portion 12. The first connecting portion 33 is detachably disposed on the second top wall 22. The liquid extraction head 32 is disposed on a side of the second top wall 22 away from the receiving cavity 4. The first housing 1 can move back and forth along a central axis “a” of the receiving cavity 4, driving the extrusion portion 12 to move back and forth relative to the liquid extraction pipe 31. The liquid extraction pipe 31 may be deformed by the extrusion portion 12 to release or absorb a liquid. The liquid extraction assembly 3 extends from the outside of the pressing unit 10 into the receiving cavity 4. Thus, the liquid extraction assembly 3 is detachably installed in the pressing unit 10, so that the liquid extraction assembly 3 can be easily taken out and replaced by a new one.

In an embodiment, the liquid extraction assembly 3 is disposable. The liquid extraction assembly 3 has no need to be cleaned after use. The liquid extraction assembly 3 can be replaced at any time according to an actual need. The pressing unit 10 is permanent and does not need replacement.

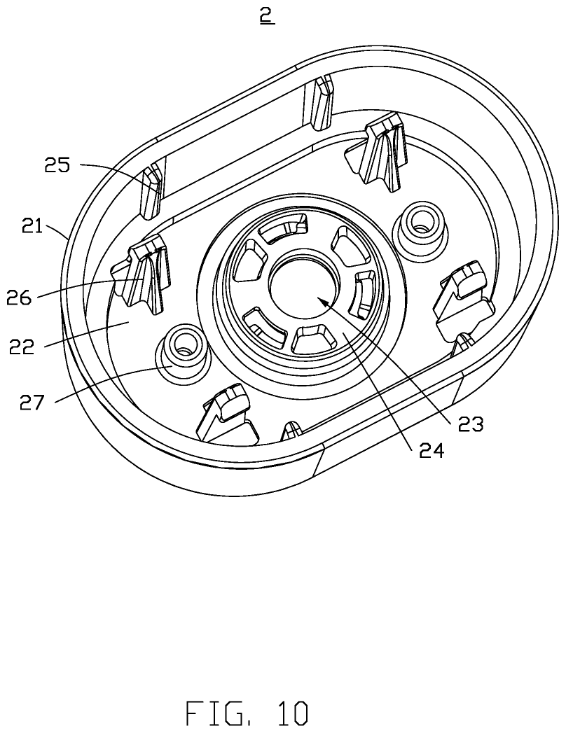

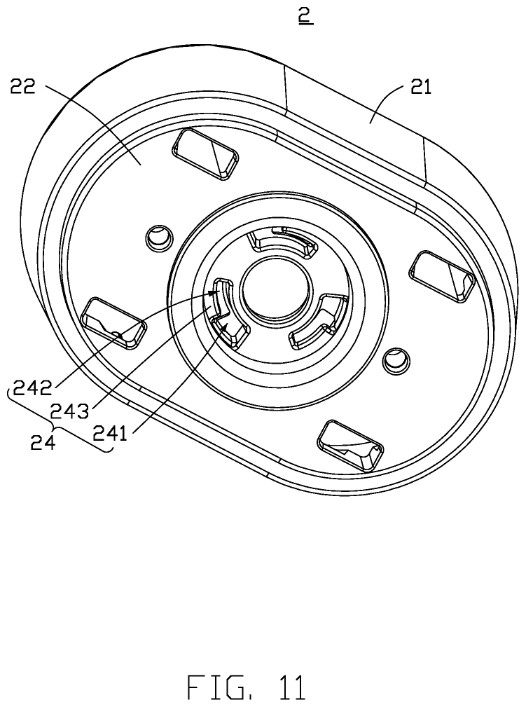

Referring to FIGS. 10 and 11, the second housing 2 further includes a second connecting portion 24 disposed on the second top wall 22. The second top wall 22 defines a first through hole 23. The second connecting portion 24 is disposed on the second top wall 22, and is located around the first through hole 23. When the liquid extraction pipe 31 extends into the receiving cavity 4 through the first through hole 23, the first connecting portion 33 is detachably connected to the second connecting portion 24.

In an embodiment, the first connecting portion 33 includes a connecting body 331, a guiding rod 333 disposed on the connecting body 331, and a hook 334 disposed on the guiding rod 333. The connecting body 331 defines a first clamping position 332. The second connecting portion 24 defines a first opening 241, a second opening 242, and a second clamping position 243. The first opening 241 penetrates the second top wall 22. The second opening 242 penetrates the second top wall 22 and connects to the first opening 241. The guiding rod 333 extends into the first opening 241 from a side of the second top wall 22 away from the receiving cavity 4 and clamps into the second opening 242. The hook 334 is clamped on a side of the second clamping position 243 close to the receiving cavity 4, and the first opening 332 is clamped on a side of the second clamping position 243 away from the receiving cavity 4. At this time, the first opening 332 and the hook 334 clamp the second clamping position 243 from opposite sides of the second clamping position 243. Thus, the first connecting portion 33 and the second connecting portion 24 are detachably connected to each other.

In yet another embodiment, an external thread (not shown) is disposed on an outer sidewall of the first connecting portion 33. An internal thread (not shown) is disposed on an inner sidewall of the second connecting portion 24. The first connecting portion 33 can threadedly engage with the second connecting portion 24 through the external thread and the internal thread.

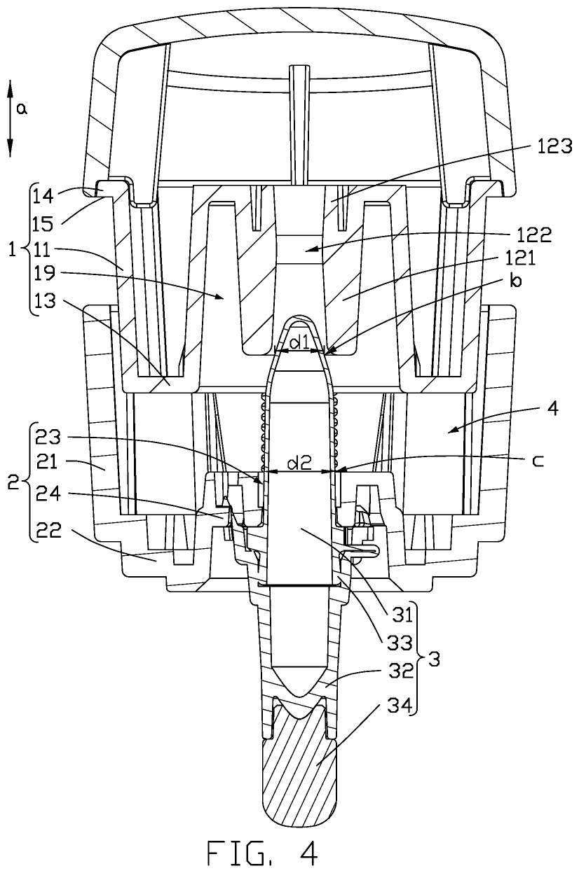

Referring to FIGS. 4, 5, 8, and 9, the extrusion portion 12 includes a third sidewall 121. One end of the third sidewall 121 is connected to the first top wall 13. The third sidewall 121 defines a second through hole 122. The second through hole 122 is connected to the first through hole 23. The second through hole 122 and the first through hole 23 are both coaxial with the receiving cavity 4. A diameter of the second through hole 122 decreases in a direction away from the first through hole 23. The liquid extraction pipe 31 extends into or out of the second through hole 122 through the first through hole 23. The third sidewall 121 can compress or release a first sidewall of the liquid extraction pipe 31 to cause the liquid extraction pipe 31 to deform or allow to rebound, thereby releasing or absorbing the liquid.

In an embodiment, at least one extrusion block 123 is disposed on a first inner surface of the third sidewall 121 close to the second through hole 122. The liquid extraction pipe 31 successively passes through the first through hole 23 and the receiving cavity 4, and finally enters the second through hole 122. The extrusion block 123 compresses the liquid extraction pipe 31 to discharge gas or liquid inside the liquid extraction pipe 31. When the liquid extraction pipe 31 reverses from the second through hole 122, the liquid extraction pipe 31 rebounds to absorb the liquid.

In an embodiment, two extrusion blocks 123 are disposed on the first inner surface of the third sidewall 121 and opposite to each other. The two extrusion blocks 123 can apply pressure to the liquid extraction pipe 31 from opposite sides to make the liquid extraction pipe 31 evenly deformed. The amount/volume of liquid absorbed by the liquid extraction pipe 31 is associated with the compression degree of the liquid extraction pipe 31. The compression degree of the liquid extraction pipe 31 can be set by adjusting a distance between the two extrusion blocks 123.

In another embodiment, only one extrusion block 123 is included. The extrusion block 123 is annular and disposed on the first inner surface of the third sidewall 121.

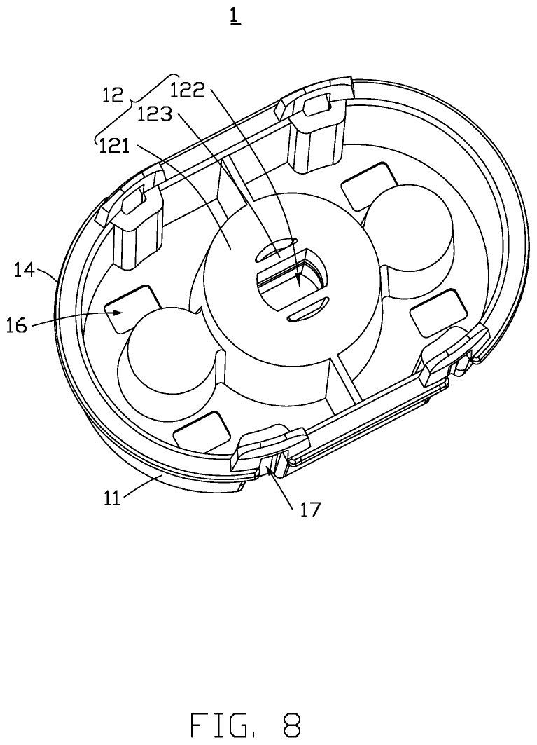

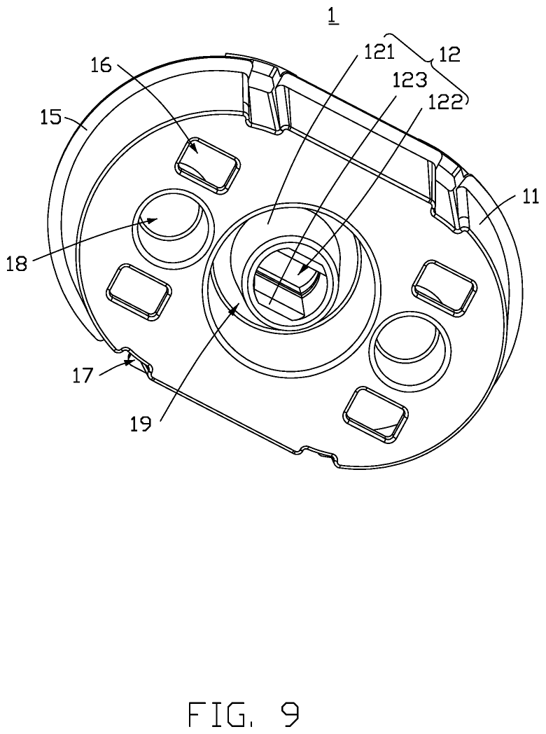

Referring to FIGS. 8 and 9, the first housing 1 further includes a fourth sidewall 14 and a platform portion 15. The fourth sidewall 14 is disposed on one end of the first sidewall 11 away from the first top wall 13. The platform portion 15 is connected to the fourth sidewall 14 and the first sidewall 11. The second sidewall 21 of the second housing 2 is sleeved on an outside of the first sidewall 11 of the first housing 1. An end of the second sidewall 21 is connected to the platform portion 15. When the first housing 1 moves back and forth along the central axis “a” of the receiving cavity 4 relative to the second housing 2, the platform portion 15 limits a moving distance of the first housing 1.

Referring to FIGS. 8 and 9, the first top wall 13 defines a positioning through hole 16. The first sidewall 11 defines a sliding slot 17. A guiding strip 25 corresponding to the sliding slot 17 is disposed on the second sidewall 21 of the second housing 2, which clamps into the sliding slot 17. A positioning rod 26 corresponding to the positioning through hole 16 is disposed on the second top wall 22 of the second housing 2, and the positioning rod 26 can extend into the positioning through hole 16 and clamp on a surface of the second top wall 22. When the first housing 1 moves back and forth relative to the second housing 2, the guiding strip 25 can move along the sliding slot 17 and the positioning rod 26 can move along the positioning through hole 16, so that the first housing 1 and the second housing 2 do not separate from each other.

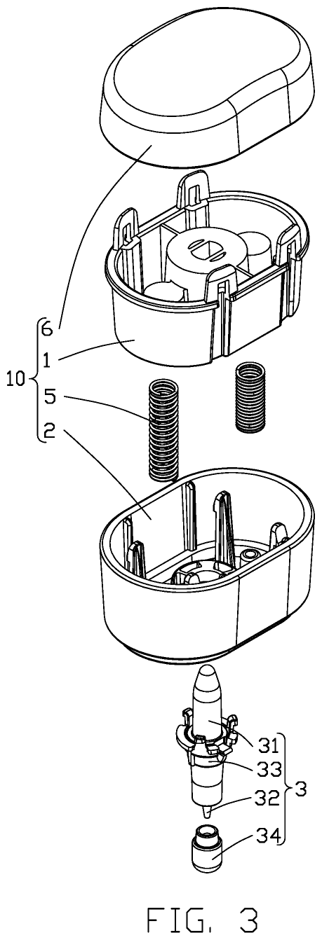

Referring to FIGS. 3, 6 and 7, the pressing unit 10 further includes an elastic member 5. One end of the elastic member 5 is connected to the first top wall 13 and the other end is connected to the second top wall 22. When the first housing 1 moves downward along the central axis “a” relative to the second housing 2, the elastic member 5 is compressed and deformed. When the first housing 1 moves up along the central axis “a” relative to the second housing 2, the elastic member 5 rebounds, and the elastic member 5 drives the first housing 1 to return to its original position. The elastic member 5 can be installed in the receiving cavity 4 when assembling the pressing unit 10, so that the liquid extraction assembly 3 can also be replaced easily.

In an embodiment, the elastic member 5 may be a spring. The first top wall 13 defines a first positioning groove 18. A guiding post 27 is disposed on the second top wall 22, which can extend into the first positioning groove 18. One end of the elastic member 5 is sleeved on the guiding post 27, and the other end extends into the first positioning groove 18 to fix the elastic member 5. A sum of depth of the first positioning groove 18 and height of the guiding post 27 is substantially equal to a length of the elastic member 5 in an uncompressed state. When the first housing 1 drives the first positioning groove 18 to move towards the guiding post 27, the guiding post 27 extends into the first positioning groove 18, and the elastic member 5 is compressed. Thus, the first positioning groove 18 limits the movement of a portion of the elastic member 5 that is not sleeved on the guiding post 27, to avoid deviation of the elastic member 5 during compression.

In an embodiment, a plurality of elastic members 5 is included. The elastic members 5 are disposed around the liquid extraction pipe 31 to apply an even pressure on the liquid extraction pipe 31, so that liquid extraction in standard units can be achieved.

In yet another embodiment, the first top wall 13 protrudes towards a side away from the receiving cavity 4 to define a second positioning groove 19. The extrusion portion 12 passes through a bottom of the second positioning groove 19. The elastic member 5 is sleeved outside of the extrusion portion 12 and embedded in the second positioning groove 19. One end of the elastic member 5 is connected to a bottom surface of the second positioning groove 19, and the other end is connected to the second top wall 22. When the liquid extraction assembly 3 is installed, the liquid extraction pipe 31 extends into the second through hole 123 of the extrusion portion 12 through the first through hole 23 and the elastic member 5. The elastic member 5 is installed in the receiving cavity 4 of the pressing unit 10, which does not need to be removed when replacing the liquid extraction assembly 3.

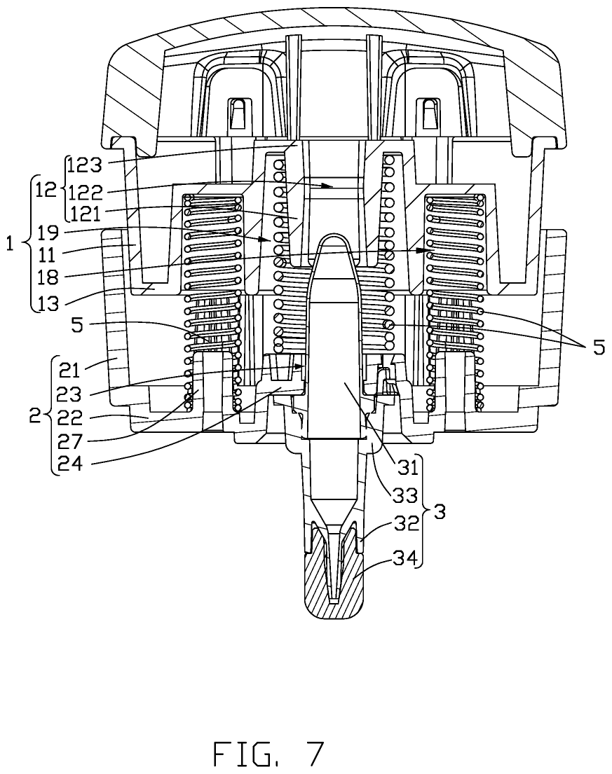

Referring to FIG. 7, the elastic members 5 can also be disposed in the first positioning groove 18 and the second positioning groove 19, which allows the extrusion portion 12 to apply a more even pressure on the liquid extraction pipe 31.

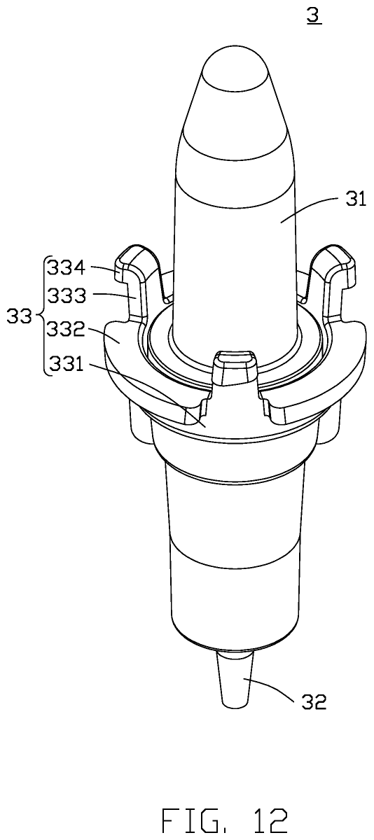

Referring to FIGS. 4, 5, and 12, the liquid extraction pipe 31 is substantially a closed hollow tube with an open end. A cross section along a direction perpendicular to the central axis “a” of the first connecting portion 33 is substantially circular. The liquid extraction head 32 is substantially a hollow tube with an opening at both ends. One end of the first connecting portion 33 is connected to the open end of the liquid extraction pipe 31, and the other end of the first connecting portion 33 is connected to the liquid extraction head 32. Thus, the liquid extraction pipe 31 is connected to the liquid extraction head 32 through the first connecting portion 33.

In an embodiment, the first connecting portion 33 and the liquid extraction head 32 are integrally formed. The liquid extraction pipe 31 is detachably installed on the first connecting portion 33. The liquid extraction assembly 3 can be formed through an injection molding process. In the injection molding process, a cavity for forming the first connecting portion 33 and the liquid extraction head 32 is connected to a cavity for forming the liquid extraction pipe 31. The first connecting portion 33, the liquid extraction head 32, and the liquid extraction pipe 31 can be injection-molded at the same time, which can short a molding cycle, improve efficiency, and reduce a manufacturing cost of the liquid extraction assembly 3. After molding, the open end of the liquid extraction pipe 31 is connected to the connecting body 331 of the first connecting portion 33 through a plastic strip (not shown). During assembly, the plastic strip is broken, and the liquid extraction pipe 31 covers the first connecting portion 33 to obtain the liquid extraction assembly 3.

In an embodiment, the liquid extraction pipe 31 is made of rubber. An outer diameter of the open end of the liquid extraction pipe 31 is slightly larger than an inner diameter of the first connecting portion 33. Therefore, the liquid extraction pipe 31 is connected to the first connecting portion 33 through an interference fit.

In an embodiment, a diameter of the cross section of the liquid extraction pipe 31 perpendicular to the central axis “a” gradually decreases from one end close to the liquid extraction head 32 to the other end away from the liquid extraction head 32. Thus, the liquid extraction pipe 31 is substantially an inverted conical pipe.

Referring to FIGS. 1 to 3, the liquid extraction assembly 3 further includes a head cover 34, which can cover an end of the liquid extraction head 32 away from the liquid extraction pipe 31, to prevent pollution of the liquid extraction head 32.

In yet another embodiment, the liquid extraction head 32 of the liquid extraction assembly 3 is a tubular structure with one open end and one closed end. The open end of the liquid extraction head 32 is connected to the first connecting portion 33 away from the liquid extraction pipe 31. When in use, the closed end of the liquid extraction head 32 is broken and inserted into a liquid for liquid extraction. The liquid extraction head 32 does not need a head cover, to reduce the cost of the liquid extraction assembly 3.

Referring to FIG. 4, the liquid transfer device 100 further includes a pressing key 6, which covers one end of the fourth sidewall 14 of the first housing 1 away from the first sidewall 11. By pressing the pressing key 6, the first housing 1 moves relative to the second housing 2.

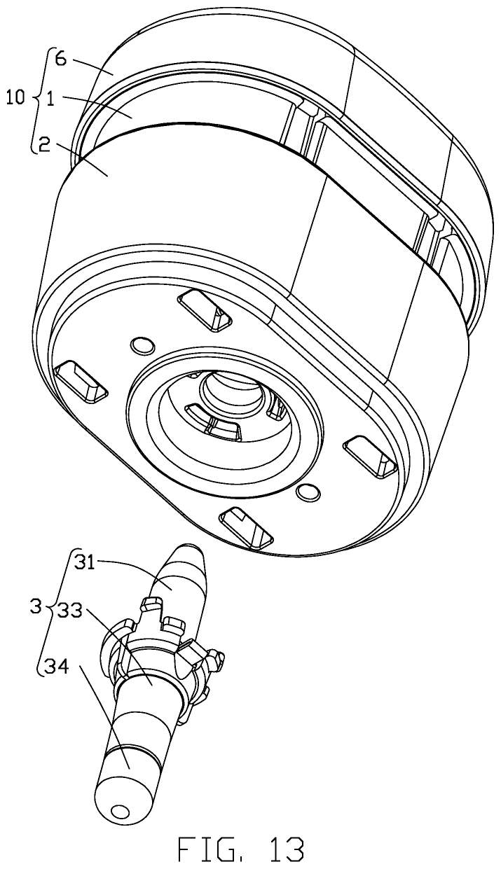

Referring to FIGS. 3, 5, 12, and 13, an assembly process of the liquid transfer device 100 includes the following steps.

At step one, the pressing unit 10 is assembled. The elastic part 5 is placed into the second housing 2. Then the first housing 1 and the second housing 2 are connected to fix the elastic part 5. Finally, the pressing key 6 is installed on the first housing 1.

At step two, the plastic strip between the liquid extraction pipe 31 and the first connecting portion 33 is broken. Then, the liquid extraction pipe 31 covers the first connecting portion 33. Thereby, the liquid extraction assembly 3 is obtained.

At step three, the liquid extraction assembly 3 is extended into the receiving cavity 4 of the pressing unit 10 through the first through hole 23. Then, the first connecting portion 33 is clamped to the second connecting portion 24 of the second housing 2 to fix the liquid extraction assembly 3 on the pressing unit 10. Thus, the liquid transfer device 100 can be obtained.

When the liquid extraction assembly 3 needs to be replaced, the liquid extraction assembly 3 can be removed from the pressing unit 10 and replaced with a new liquid extraction assembly 3.

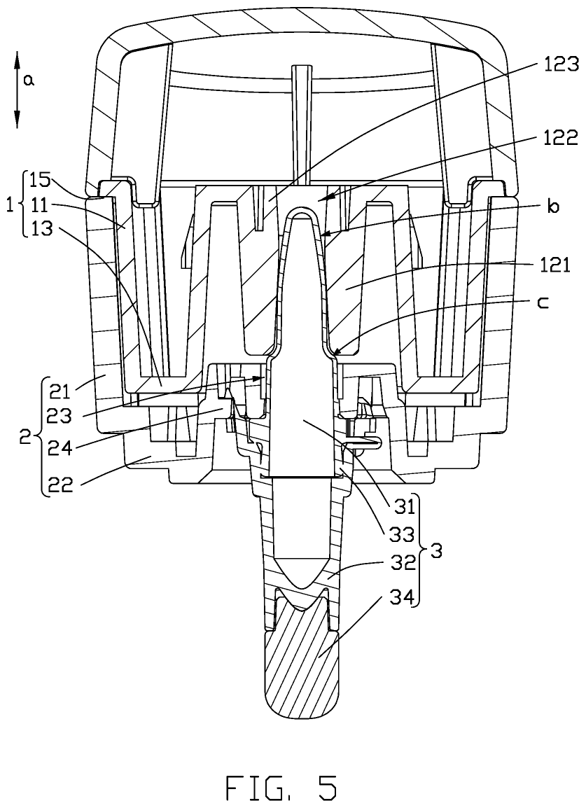

Referring to FIGS. 4 and 5, a portion of the liquid extraction pipe 31 away from the liquid extraction head 32 has a small inner diameter “D₁”, such portion being referred to as smaller end “b”. Another portion of the liquid extraction pipe 31 close to the liquid extraction head 32 has a large inner diameter “D₂”, such portion being referred to as larger end “c”. Referring to FIG. 4, when the liquid extraction pipe 31 is not compressed, the smaller end “b” is located at the bottom of the two extrusion blocks 123, and surfaces of the two extrusion blocks 123 are connected to a top of the liquid extraction pipe 31. Referring to FIG. 5, when the first housing 1 moves down, the liquid extraction pipe 31 extends out of an opening of the two extrusion blocks 123 away from the liquid extraction head 32, so that the liquid extraction pipe 31 is compressed by the extrusion blocks 123. Finally, the smaller end “b” of the liquid extraction pipe 31 extends into a top of the second through hole 122, the larger end “c” is located at the bottom of the two extrusion blocks 123, and the two extrusion blocks 123 squeeze and compress a sidewall of the liquid extraction pipe 31 to discharge air or other contents of the liquid extraction pipe 31. When the liquid extraction head 32 is immersed into a liquid, the first housing 1 can be released, and the elastic member 33 rebounds and drives the first housing 1 back to its original position, so that the liquid extraction pipe 31 exits from the two extrusion blocks 123, and the liquid extraction pipe 31 can self-restore to absorb the liquid. The compression degree of the liquid extraction pipe 31 can be controlled to control the volume of the absorbed liquid, so as to achieve precise quantities of liquid. The compression degree of the liquid extraction pipe 31 can be controlled by designing the inner diameter “D₁” and the inner diameter “D₂” of the liquid extraction pipe 31, a distance between the two extrusion blocks 123, the contact area between the two extrusion blocks 123 and the liquid extraction pipe 31, and a movement stroke of the first housing 1 relative to the second housing 2.

When in use, the pressing key 6 is pressed to drive the first housing 1 to move down along a sidewall of the second housing 2 to compress the liquid extraction pipe 31. Thus, air inside the liquid extraction pipe 31 is pushed out, causing the liquid extraction head 32 to discharge the liquid. At this time, the elastic member 5 is compressed. Then, the pressing key 6 is released, the elastic part 5 rebounds and pushes the first housing 1 to return to its original position. The extrusion block 123 moves up relative to the liquid extraction pipe 31 and releases the liquid extraction pipe 31, causing the liquid extraction pipe 31 to take up liquid. The first housing 1 can be pressed again to move down relative to the second housing 2, which further compresses the liquid extraction pipe 31 to discharge the liquid out.

The liquid transfer device 100 provided by the present disclosure can be used to transfer a variety of liquid samples. For example, the liquid samples may be, but is not limited to, a biological sample, a veterinary sample, or an environmental sample.

The liquid transfer device 100 provided by the present disclosure can be used to collect and prepare volumes of 1 μl˜5 ml (such as 1 μl, 2 μl, 4 μl, 5 μl, 10 μl, 20 μl, 50 μl. 100 μl, 200 μl, 500 μl. 1 ml, 2 ml, and 5 ml of liquid, and any volumes in between).

The liquid transfer device 100 has the advantages of simple overall structure, low cost, convenient operation, and can achieve precise discharges and take-ups of liquid. The liquid extraction assembly 3 is detachably installed in pressing unit 10. The pressing unit 10 is recyclable. The liquid extraction assembly 3 is disposable, which can be easily replaced.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure, up to and including, the full extent established by the broad general meaning of the terms used in the claims.

What is claimed is:

1. A liquid transfer device, comprising:
a pressing unit; and
a liquid extraction assembly;
wherein the pressing unit comprises a first housing and a second housing, the first housing comprises a first sidewall, a first top wall, and a extrusion portion, the first sidewall is connected to the first top wall, the extrusion portion is disposed on the first top wall, the second housing comprises a second sidewall and a second top wall, the second sidewall is connected to the second top wall, the second sidewall and the second top wall cooperatively define a receiving cavity, the first housing is received in the receiving cavity;
wherein the liquid extraction assembly comprises a liquid extraction pipe, a liquid extraction head, and a first connecting portion, the liquid extraction head is connected to the liquid extraction pipe through the first connecting portion, the liquid extraction assembly extends into the receiving cavity through the second top side and corresponds to the extrusion portion, the first connecting portion is detachably disposed on the second top wall, the liquid extraction head is disposed out of the receiving cavity, the first housing is configured to move back and forth along a central axis of the receiving cavity, so as to drive the extrusion portion to move back and forth relative to the liquid extraction pipe, thereby causing the liquid extraction pipe to be compressed and rebounded to release or absorb a liquid.

2. The liquid transfer device of claim 1, wherein the second housing further comprises a second connecting portion disposed on the second top wall, the second top wall defines a first through hole, the second connecting portion is disposed on the second top wall, and is located around the first through hole, when the liquid extraction pipe extends into the receiving cavity through the first through hole, the first connecting portion is detachably connected to the second connecting portion.

3. The liquid transfer device of claim 2, wherein the first connecting portion comprises a connecting body, a guiding rod disposed on the connecting body, and a hook disposed on the guiding rod, the connecting body defines a first clamping position,
the second connecting portion defines a first opening, a second opening, and a second clamping position, the first opening penetrates the second top wall, the second opening penetrates the second top wall and connects to the first opening,
the guiding rod extends into the first opening from the second top wall and clamps into the second opening, the hook is clamped on a side of the second clamping position close to the receiving cavity, and the first opening is clamped on a side of the second clamping position away from the receiving cavity, thereby the first connecting portion is detachably connected to the second connecting portion.

4. The liquid transfer device of claim 3, wherein the first connecting portion and the second connecting portion are threadedly connected to each other.

5. The liquid transfer device of claim 2, wherein the extrusion portion comprises a third sidewall, one end of the third sidewall is connected to the first top wall, the third sidewall defines a second through hole, the second through hole and the first through hole are connected together and are coaxial with the receiving cavity,
a diameter of the second through hole decreases in a direction away from the first through hole, the liquid extraction pipe is configured to extend into or exit out of the second through hole, the third sidewall is configured to compress or release the liquid extraction pipe.

6. The liquid transfer device of claim 5, wherein a diameter of a cross section of the liquid extraction pipe perpendicular to the central axis gradually decreases from one end close to the liquid extraction head to another end away from the liquid extraction head.

7. The liquid transfer device of claim 5, wherein at least one extrusion block is disposed on an inner surface of the third sidewall, and at least one extrusion block is configured to compress or release the liquid extraction pipe.

8. The liquid transfer device of claim 7, wherein two extrusion blocks are disposed on an inner surface of the third sidewall and opposite to each other, the two extrusion blocks are configured to compress the liquid extraction pipe from opposite sides.

9. The liquid transfer device of claim 7, wherein the extrusion block is annular and disposed on an inner surface of the third sidewall.

10. The liquid transfer device of claim 5, wherein the first housing further comprises a fourth sidewall and a platform portion, the fourth sidewall is disposed on one end of the first sidewall away from the first top wall, the platform portion is connected to the fourth sidewall and the first sidewall,
the second sidewall of the second housing is sleeved on an outside of the first sidewall of the first housing, an end of the second sidewall is connected to the platform portion.

11. The liquid transfer device of claim 1, wherein the first top wall defines a positioning through hole, the first sidewall defines a sliding slot, a guiding strip corresponding to the sliding slot is disposed on the second sidewall of the second housing, the guiding strip is configured to clamp into the sliding slot, a positioning rod corresponding to the positioning through hole is disposed on the second top wall of the second housing, and the positioning rod extends into the positioning through hole and clamps on a surface of the second top wall.

12. The liquid transfer device of claim 2, wherein the pressing unit further comprises an elastic member received in the receiving cavity, one end of the elastic member is connected to the first top wall, and the other end is connected to the second top wall, the elastic member is configured to drive the first housing to move away from the second housing.

13. The liquid transfer device of claim 2, wherein the pressing unit further comprises a plurality of elastic members received in the receiving cavity, one end of each of the plurality of elastic members is connected to the first top wall, and the other end is connected to the second top wall, the plurality of elastic members are disposed around the liquid extraction pipe, the plurality of elastic members are configured to drive the first housing to move away from the second housing.

14. The liquid transfer device of claim 13, wherein the pressing unit further comprises another elastic member sleeved outside of the extrusion portion.

15. The liquid transfer device of claim 1, wherein an outer diameter of an opening of the liquid extraction pipe is larger than an inner diameter of the first connecting portion.

16. The liquid transfer device of claim 1, wherein the liquid extraction assembly further comprises a head cover, the head cover covers an end of the liquid extraction head away from the liquid extraction pipe.

17. The liquid transfer device of claim 1, wherein the liquid extraction head comprises an open end and a closed end, and the open end is connected to the first connecting portion.

18. The liquid transfer device of claim 1, further comprising a pressing key disposed on one end of the first housing away from the liquid extraction head.
